(19) United States
(12) Patent Application Publication
(10) Pub. No.: US 2014/0185162 A1
(43) Pub. Date: Jul. 3, 2014

(54) BASE ASSEMBLY AND HARD DISK DRIVE INCLUDING THE SAME

(71) Applicant: SAMSUNG ELECTRO-MECHANICS CO., LTD., Suwon (KR)

(72) Inventor: Nam Ki PARK, Suwon (KR)

(73) Assignee: Samsung Electro-Mechanics Co., Ltd., Suwon (KR)

(21) Appl. No.: 13/793,469

(22) Filed: Mar. 11, 2013

(30) Foreign Application Priority Data
Dec. 28, 2012 (KR) 10-2012-0156967

(51) Int. Cl. G11B 33/12

(52) U.S. Cl. CPC G11B 33/123
USPC 360/99.08; 360/99.12

(57) ABSTRACT

There is provided a base assembly including a motor mounting part, and a base body including a disk mounting part coupled to the motor mounting part and having a disk disposed thereon, the disk having data stored therein, and a head seating part formed in a position lower than that of the disk mounting part, wherein the motor mounting part is formed of a non-magnetic material, and the base body is formed of a magnetic material.

### CROSS-REFERENCE TO RELATED APPLICATIONS

This application claims the priority of Korean Patent Application No. 10-2012-0156967 filed on Dec. 28, 2012, in the Korean Intellectual Property Office, the disclosure of which is incorporated herein by reference.

### BACKGROUND OF THE INVENTION

1. Field of the Invention

The present invention relates to a base assembly and a hard disk drive including the same.

2. Description of the Related Art

A hard disk drive (HDD), an information storage device of a computer, reads data stored on a disk or writes data to a disk using a magnetic head.

In a hard disk drive, a base member is installed with a head driver, that is, a head stack assembly (HSA), capable of moving the magnetic head on the disk. The magnetic head performs its function while moving to a desired position in a state in which it is suspended above a writing surface of the disk at a predetermined height by the head driver.

According to the related art, in manufacturing a base member provided in the hard disk drive, a post-processing scheme of die-casting aluminum (Al) and then removing burrs, or the like, generated due to the die-casting has been used.

However, in the die-casting scheme according to the related art, since a process of injecting aluminum (Al) in a molten state for forging to form a shape thereof is performed, high levels of temperature and pressure are required, such that a large amount of energy is required in the process and a processing time is increased.

Further, in terms of a lifespan of a die-casting mold, there is a limitation in manufacturing a large number of base plates using a single mold, and a base plate manufactured by the die-casting process has poor dimensional precision.

Therefore, in order to solve problems of the die-casting process, the base plate has been manufactured by a pressing or forging process. However, in the case of manufacturing the base plate by the pressor forging process, the base plate basically has a uniform thickness, such that it is difficult to implement a fine shape therein.

Further, in the case of manufacturing the base plate by performing press working on a steel sheet, since the base plate is provided as a magnetic material, a flow of magnetic flux from a magnet generating rotational driving force of a spindle motor toward a coil may become unstable.

### SUMMARY OF THE INVENTION

An aspect of the present invention provides a base assembly allowing a flow of magnetic flux generating rotational driving force of a spindle motor to be smooth and improving the overall rigidity of a hard disk drive even in the case that a base body is manufactured by plastically deforming a steel sheet, and a hard disk drive including the same.

According to an aspect of the present invention, there is provided a base assembly including: a motor mounting part; and a base body including a disk mounting part coupled to the motor mounting part and having a disk disposed thereon, the disk having data stored therein, and a head seating part formed in a position lower than that of the disk mounting part, wherein the motor mounting part is formed of a non-magnetic material, and the base body is formed of a magnetic material.

The motor mounting part may be formed of aluminum (Al), and the base body may be formed of a cold rolled steel sheet, a hot rolled steel sheet, stainless steel, a boron alloy, or a magnesium alloy.

The base body may be formed by plastically deforming a steel sheet.

The disk mounting part may have an insertion hole formed in a center thereof such that the motor mounting part is inserted thereinto and fixed thereto.

The motor mounting part may be coupled to the insertion hole by at least one of a sliding method, an adhering method, a welding method, and a press-fitting method.

The motor mounting part may have a step part formed on an outer edge thereof such that the base body is seated thereon.

An edge portion of an insertion hole formed in the disk mounting part may be provided with a coupling part extended downwardly in an axial direction.

The coupling part may have an inner peripheral surface entirely contacting an outer peripheral surface of the motor mounting part and coupled thereto.

The motor mounting part may be coupled to the coupling part by at least one of a sliding method, an adhering method, a welding method, and a press-fitting method.

According to another aspect of the present invention, there is provided a hard disk drive including: the base assembly as described above; a spindle motor coupled to the base assembly to rotate the disk; a magnetic head writing data to the disk and reading the data from the disk; and a head driver moving the magnetic head to a predetermined position on the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic exploded perspective view showing a hard disk drive according to an embodiment of the present invention;

FIG. 2 is an exploded perspective view of a base assembly according to an embodiment of the present invention;

FIG. 3 is a schematic cross-sectional view showing a state in which a spindle motor is mounted on the base assembly according to the embodiment of the present invention;

FIG. 4 is a half cross-sectional perspective view of the base assembly according to the embodiment of the present invention;

FIG. 5 is a schematic cross-sectional view showing a state in which a spindle motor is mounted on a base assembly according to another embodiment of the present invention;

FIG. 6 is a half cross-sectional perspective view of the base assembly according to another embodiment of the present invention; and

FIG. 7 is a schematic cross-sectional view showing a flow of magnetic flux from a magnet of a spindle motor toward a coil in the case of using the base assembly according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

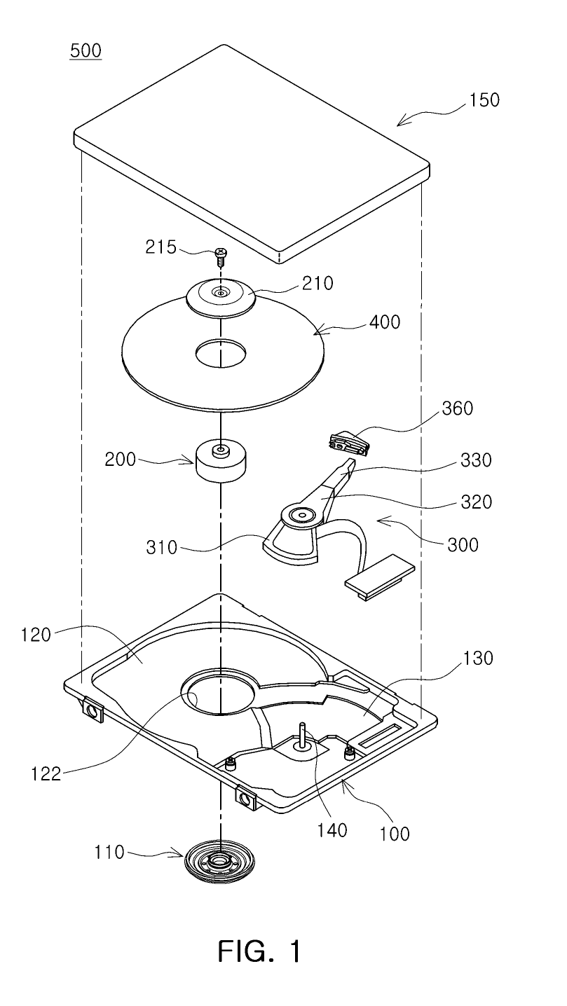

FIG. 1 is a schematic exploded perspective view showing a hard disk drive according to an embodiment of the present invention.

Referring to FIG. 1, a hard disk drive 500 according to the embodiment of the present invention may include a base assembly, a spindle motor 200, and a head driver 300.

The base assembly refers to a housing forming, together with a cover part 150, an exterior of the hard disk drive 500 according to the embodiment of the present invention, and may include a base body 100 including a motor mounting part 110, a disk mounting part 120, and a head seating part 130.

Here, the base assembly and the cover part 150 may be coupled to each other by screwing a plurality of screws (not shown) into holes (not shown) formed in the base assembly.

The motor mounting part 110 may be inserted into and fixed to an insertion hole 122 formed in the center of the disk mounting part 120 and have the spindle motor 200 disposed thereon.

The base body 100 may include the disk mounting part 120 on which a disk 400 having data stored therein is disposed and the head seating part 130 on which the head driver 300 providing driving force to a magnetic head is disposed.

The disk mounting part 120, a part on which the disk 400 coupled to a spindle motor 200 to be described below is disposed, may have the disk 400 positioned thereon, wherein the disk 400 has the data stored therein.

The disk mounting part 120 may be formed to have a generally circular shape so as to correspond to a shape of the disk 400 and, a portion of the disk mounting part 120 is formed in a stepped manner to configure the head seating part 130 on which the head driver 300 to be described below is disposed.

Here, the head seating part 130 is disposed in a position lower than that of the disk mounting part 120 to thereby provide a space in which the head driver 300 is repeatedly rotated so as to read data from the disk 400 and write data to the disk 400.

That is, the head seating part 120 is disposed in a position lower than that of the base body 110 to thereby secure a space in which the head driver 300 provides driving force to a magnetic head (not shown) to move the magnetic head (not shown) to the disk 400, thereby reading data from the disk 400 and writing data to the disk 400.

Meanwhile, the disk mounting part 120 may have the motor mounting part 110 coupled to the center thereof so as to fix the spindle motor 200.

A coupling structure between the motor mounting part 110 and the disk mounting part 120, and materials and effects of the motor mounting part 110 and the disk mounting part 120 will be described below.

The spindle motor 200, provided to rotate the disk 400, is fixed to the motor mounting part 110 of the base assembly.

The disk 400, coupled to the spindle motor 200 to rotate together with the spindle motor 200, may have a writing surface on which data is written.

Here, the spindle motor 200 may include a clamp 210 coupled to an upper end portion thereof by a screw 215 in order to firmly fix the disk 400 thereto.

In addition, although a configuration in which a single disk 400 is mounted on the spindle motor 200 is shown in FIG. 1, it is only an example. That is, one or more disks 400 may be mounted on the spindle motor 200. In the case in which a plurality of disks 400 are mounted as described above, a ring shaped spacer for maintaining an interval between the disks 400 may be disposed between the disks 400.

The head driver 300, known as a head stack assembly (HSA), may have a magnetic head (not shown) mounted thereon, and may move the magnetic head to a predetermined position to write the data to the disk 400 or read data written on the disk 400.

The head driver 300 may include a voice coil motor (VCM), a swing arm 320, and a suspension 330, wherein the suspension 330 may be fixedly coupled to a front end portion of the swing arm 320.

In addition, the head driver 300 may be coupled to the base assembly so as to be rotatable around a pivot axis 140 of the head seating part 130 of the base assembly, and the magnetic head (not shown) may serve to read data stored on the writing surface of the disk 400 or write data to the writing surface of the disk 400 when the disk 400 rotates on the disk mounting part 120 of the base assembly at a high speed.

Here, the VCM, providing rotational driving force to the head driver 300, may include magnets (not shown) disposed upwardly and downwardly of a VCM coil 310 of the head driver 300.

The VCM may be controlled by a servo control system and rotate the head driver 300 around the pivot axis 160 in a direction according to Fleming's left hand rule by an interaction between current input by the VCM coil 310 and a magnetic field formed by the magnets (not shown).

Here, when an operation start command is input to the hard disk drive according to the embodiment of the present invention, the disk 400 starts to rotate, and the VCM may rotate the swing arm 320 in a counterclockwise direction to move the magnetic head (not shown) onto the writing surface of the disk 400.

On the other hand, when an operation stop command is input to the hard disk drive according to the embodiment of the present invention, the VCM rotates the swing arm 320 in a clockwise direction to allow the magnetic head (not shown) to deviate from the disk 400.

The magnetic head (not shown) deviating from the writing surface of the disk 400 is parked in a ramp 360 provided at an outer side of the disk 400.

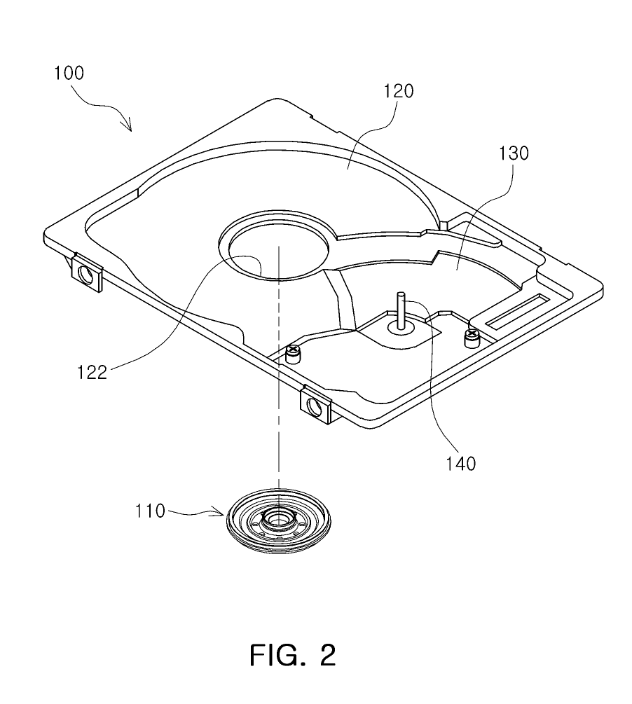

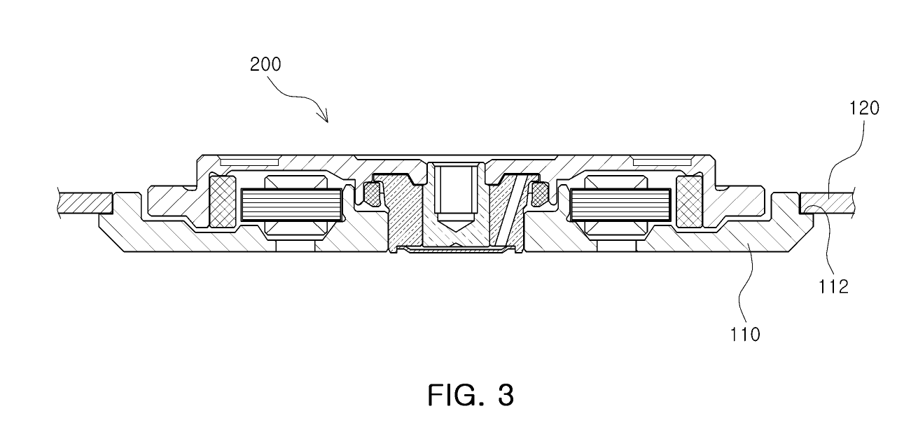

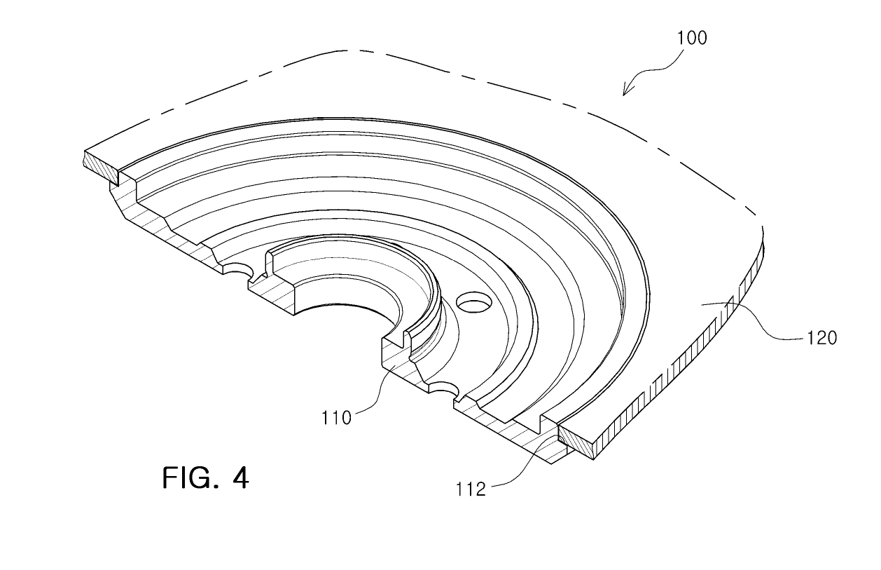

FIG. 2 is an exploded perspective view of a base assembly according to an embodiment of the present invention; FIG. 3 is a schematic cross-sectional view showing a state in which a spindle motor is mounted on the base assembly according to the embodiment of the present invention; and FIG. 4 is a half cross-sectional perspective view of the base assembly according to the embodiment of the present invention.

Referring to FIGS. 2 through 4, the base assembly according to the embodiment of the present invention may include the motor mounting part 110 and the base body 100.

The base body 100 may include the disk mounting part 120 on which the disk 400 having data stored therein is disposed and the head seating part 130 on which the head driver 300 providing driving force to a magnetic head is disposed.

The disk mounting part 120 may be coupled to the motor mounting part 110 and may have the insertion hole 122 formed in the center thereof such that the motor mounting part 110 is inserted thereinto and fixed thereto.

The motor mounting part 110 may be coupled to the insertion hole 122 by at least one of a sliding method, an adhering method, a welding method, and a press-fitting method.

Here, the motor mounting part 110 may have a step part 112 formed on an outer edge thereof such that the disk mounting part 120 is seated thereon, and the disk mounting part 120 may be seated on and fixed to the step part 112.

That is, the motor mounting part 110 and the disk mounting part 120 may be provided as separate members and then coupled to each other, and may be formed of different materials.

The motor mounting part 110 may be formed of a non-magnetic material, and the base body 100 including the disk mounting part 120 may be formed of a magnetic material.

Here, the base body 100 may be formed by plastically deforming a steel sheet formed of a magnetic material.

That is, the base body 100 may be manufactured by performing plastic deformation on a sheet, that is, a cold rolled steel sheet (SPCC, SPCE, or the like), a hot rolled steel sheet, stainless steel, or a lightweight alloy steel sheet such as a boron or magnesium alloy, or the like.

That is, after a basic shape of the base body 100 is manufactured using a pressing or forging process, the entire shape of the base body 100 may be formed by post-processes such as bending process, a cutting process, and the like.

Here, a pressing or forging scheme according to the embodiment of the present invention overcoming disadvantages such as high energy consumption, a long processing time, and the like in a die-casting scheme according to the related art, is significantly effective in view of process efficiency; however, it is difficult to form a complex structure due to characteristics of the press or forging scheme.

Therefore, in the base assembly according to the embodiment of the present invention, the base body 100 is manufactured by plastically deforming the steel sheet while the motor mounting part 110 on which the spindle motor 200 is disposed is manufactured by a die-casting scheme, whereby rigidity of the base assembly may be secured and a complex internal structure may be easily formed.

In addition, the motor mounting part 110 is formed of a non-magnetic material, whereby a flow of magnetic flux rotating the spindle motor 200 may be smooth.

Generally, in the case of manufacturing the base body by plastically deforming the steel sheet, a flow of magnetic flux from a magnet generating rotational driving force of a spindle motor toward a coil may be unstable due to the fact that the base body is formed of a magnetic material.

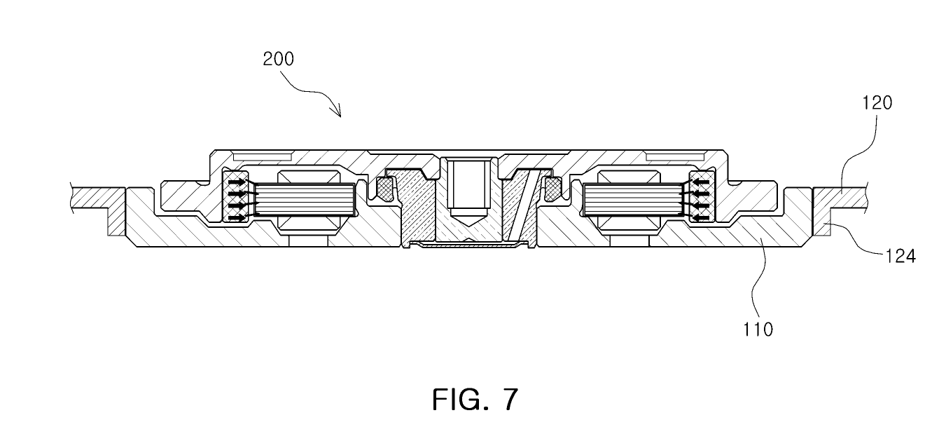

Therefore, in the base assembly according to the embodiment of the present invention, the base body 100 is formed of a magnetic material and the motor mounting part 110 is formed of a non-magnetic material, such that the flow of magnetic flux from the magnet to the coil may be smooth as shown in FIG. 7.

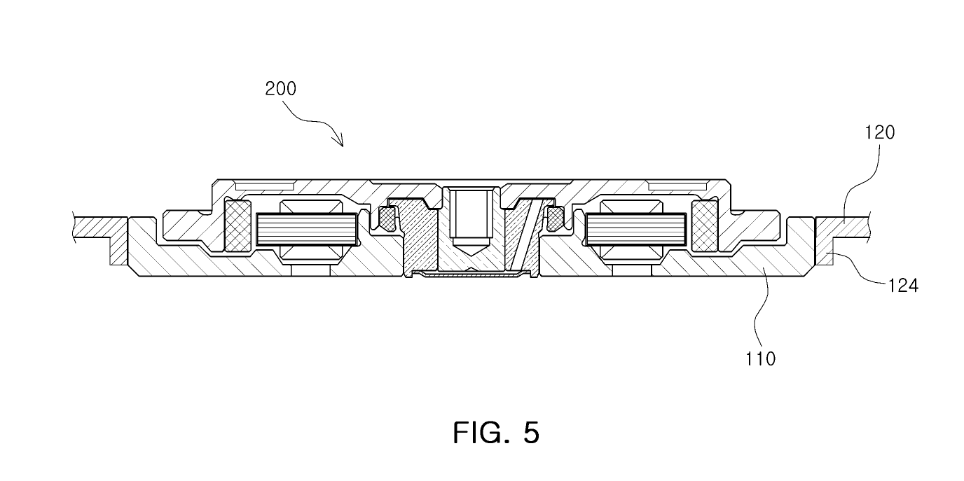

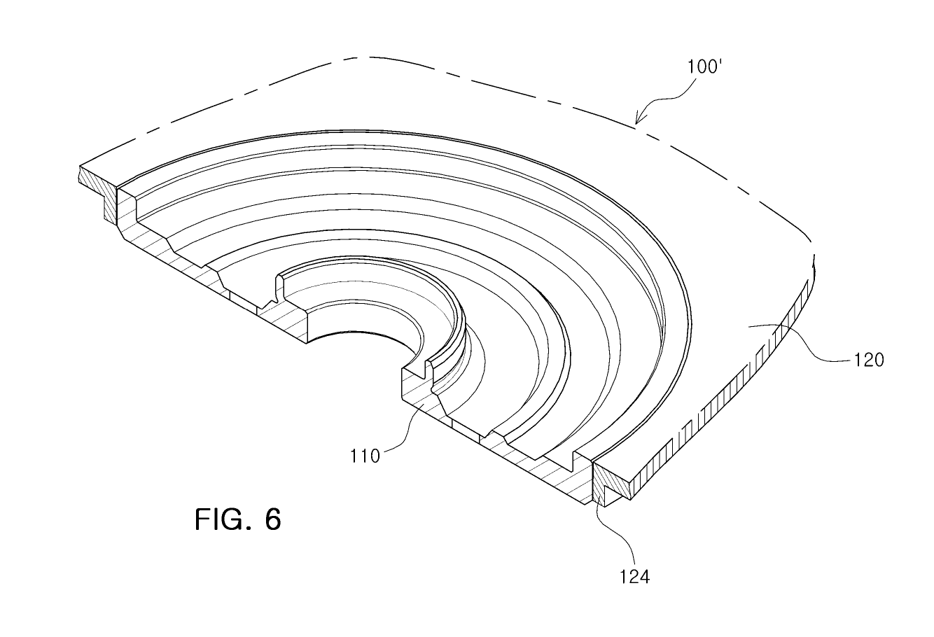

FIG. 5 is a schematic cross-sectional view showing a state in which a spindle motor is mounted on a base assembly according to another embodiment of the present invention; FIG. 6 is a half cross-sectional perspective view of the base assembly according to another embodiment of the present invention; and FIG. 7 is a schematic cross-sectional view showing a flow of magnetic flux from a magnet of a spindle motor toward a coil in the case of using the base assembly according to the embodiment of the present invention.

Referring to FIGS. 5 through 7, the base assembly according to another embodiment of the present invention is the same as the base assembly according to the embodiment of the present invention except for a coupling structure between the motor mounting part 110 and the disk mounting part 120. Therefore, a description of configurations other than the coupling structure between the motor mounting part 110 and the disk mounting part 120 will be omitted.

The disk mounting part 120 may be coupled to the motor mounting part 110 and have the insertion hole 122 formed in the center thereof such that the motor mounting part 110 is inserted thereinto and fixed thereto.

Here, an edge portion of the insertion hole 122 formed in the disk mounting part 120 may be provided with a coupling part 124 extended downwardly in an axial direction, and in this case, the coupling part 124 may have an inner peripheral surface entirely contacting an outer peripheral surface of the motor mounting part 110 and coupled thereto.

The motor mounting part 110 may be coupled to the coupling part 124 by at least one of a sliding method, an adhering method, a welding method, and a press-fitting method.

Since the coupling part 124 formed on the disk mounting part 120 may entirely contact the motor mounting part 110, a contact area between the disk mounting part 120 and the motor mounting part 110 may be increased. Therefore, coupling force between the disk mounting part 120 and the motor mounting part 110 may be improved.

Meanwhile, a base body 100′ may be formed of a magnetic material and the motor mounting part 110 may be formed of a non-magnetic material, whereby a flow of magnetic flux rotating the spindle motor 200 may be smooth.

Generally, in the case of manufacturing the base body by plastically deforming the steel sheet, a flow of magnetic flux from a magnet generating rotational driving force of a spindle motor toward a coil may be unstable due to the base body formed of a magnetic material.

Therefore, in the base assembly according to another embodiment of the present invention, the base body 100 is formed of a magnetic material and the motor mounting part 110 is formed of a non-magnetic material, such that the flow of magnetic flux from the magnet to the coil may be smooth, as shown in FIG. 7.

As set forth above, with the base assembly and the hard disk drive including the same according to the embodiments of the present invention, even in the case that the base body is manufactured by plastically deforming the steel sheet, the flow of magnetic flux generating the rotational driving force of the spindle motor can be smooth and the overall rigidity of the hard disk drive can be improved.

In addition, the base plate 100 or 100′ may be manufactured by the forging or pressing process to significantly decrease a processing time and energy consumption, whereby production capability can be significantly increased.

While the present invention has been shown and described in connection with the embodiments, it will be apparent to those skilled in the art that modifications and variations can be made without departing from the spirit and scope of the invention as defined by the appended claims.

What is claimed is:

1. A base assembly comprising:
a motor mounting part; and
a base body including a disk mounting part coupled to the motor mounting part and having a disk disposed thereon, the disk having data stored therein, and a head seating part formed in a position lower than that of the disk mounting part,
wherein the motor mounting part is formed of a non-magnetic material, and the base body is formed of a magnetic material.

2. The base assembly of claim 1, wherein the motor mounting part is formed of aluminum (Al), and the base body is formed of a cold rolled steel sheet, a hot rolled steel sheet, stainless steel, a boron alloy, or a magnesium alloy.

3. The base assembly of claim 1, wherein the base body is formed by plastically deforming a steel sheet.

4. The base assembly of claim 1, wherein the disk mounting part has an insertion hole formed in a center thereof such that the motor mounting part is inserted thereinto and fixed thereto.

5. The base assembly of claim 4, wherein the motor mounting part is coupled to the insertion hole by at least one of a sliding method, an adhering method, a welding method, and a press-fitting method.

6. The base assembly of claim 1, wherein the motor mounting part has a step part formed on an outer edge thereof such that the base body is seated thereon.

7. The base assembly of claim 1, wherein an edge portion of an insertion hole formed in the disk mounting part is provided with a coupling part extended downwardly in an axial direction.

8. The base assembly of claim 7, wherein the coupling part has an inner peripheral surface entirely contacting an outer peripheral surface of the motor mounting part and coupled thereto.

9. The base assembly of claim 7, wherein the motor mounting part is coupled to the coupling part by at least one of a sliding method, an adhering method, a welding method, and a press-fitting method.

10. A hard disk drive comprising:
the base assembly of claim 1;
a spindle motor coupled to the base assembly to rotate the disk;
a magnetic head writing data to the disk and reading the data from the disk; and
a head driver moving the magnetic head to a predetermined position on the disk.
